(19) United States
(12) Patent Application Publication
(10) Pub. No.: US 2021/0152571 A1
(43) Pub. Date: May 20, 2021

(54) SYSTEMS AND METHODS FOR DETECTING SECURITY INCIDENTS

(71) Applicant: Citrix Systems, Inc., Fort Lauderdale, FL (US)

(72) Inventors: Andreas Varnavas, Patras (GR); Nikolaos Tsapakis, Patras (GR)

(21) Appl. No.: 16/714,240

(22) Filed: Dec. 13, 2019

Related U.S. Application Data
(63) Continuation of application No. PCT/GR2019/000082, filed on Nov. 20, 2019.

(51) Int. Cl. H04L 29/06

(52) U.S. Cl. CPC H04L 63/1416; H04L 63/1466

(57) ABSTRACT

Systems and methods for identifying potential security incidents include an analytics engine that identifies a detection threshold for login failures according to a number of login successes to a system. The analytics engine may determine a number of login failures by a plurality of users to the system within a time window. The analytics engine may determine that the number of login failures to the system within the time window exceeds the detection threshold. The analytics engine may provide a notification to a device indicating a potential security incident responsive to the number of login failures exceeding the detection threshold.

### CROSS-REFERENCE TO RELATED APPLICATION

This application is a continuation of International Application No. PCT/GR2019/000082, filed Nov. 20, 2019, the content of which is incorporated herein by reference in its entirety.

### FIELD OF THE DISCLOSURE

The present application generally relates to detection of security incidents, including but not limited to systems and methods for detecting a password spraying, credential stuffing, or other similar types of security incidents for a service for instance.

### BACKGROUND

In a computing environment, various services may be offered to computing devices for performing various tasks. Some services may be password protected. As such, users of the computing devices may provide their login credentials to access a particular service. Some services may be vulnerable to security incidents, such as password spraying, credential stuffing, etc.

### SUMMARY

This Summary is provided to introduce a selection of concepts in a simplified form that are further described below in the Detailed Description. This Summary is not intended to identify key features or essential features, nor is it intended to limit the scope of the claims included herewith.

The following disclosure is directed to systems and methods for detecting a security incident. Specifically, the systems and methods described herein are configured to detect or identify various attempted attacks or other security incidents (such as password spraying, credential stuffing, or other types of incidents) to a service. Briefly, the systems and methods described herein compute or determine a detection threshold for the number of distinct failed login attempts (per username) to a service. The threshold may adapt based on successful login attempts to the system, to provide an adaptive detection system that optimizes the detection threshold according to the “size” of the service, system and/or login activity.

In various computing environments, services (e.g., systems, applications, working environments, user accounts and/or resources) which may be accessed by users (e.g., via user or client devices) may be password protected. Malicious actors or entities may attempt to access such services by “attacking” the password protection system of such services. For instance, an attempted attack may include a large number of login attempts against a large number of usernames, while keeping the number of login attempts per username low. The idea behind these attacks is that by keeping the number of login attempts per username low, they remain undetected by traditional security defenses which aim to detect brute force attacks on isolated users (e.g., which may block access via a username after a predetermined number of attempts to access a service using that particular username). Moreover, such attacks are designed to remain undetected by exploiting the fact that the number of legitimate failed login attempts across a system can be large and can have large variability. Examples of such attacks are password spraying attacks, credential stuffing attacks, and so forth. In the case of password spraying attacks, a small set of commonly used passwords are attempted against a large number of usernames for a service. In the case of credential stuffing attacks, previously discovered (e.g. stolen) account credentials, typically usernames and passwords which are separate from each other, are attempted in various combinations against a service.

The systems and methods described herein may be configured to provide real-time detection of such attacks, and thereby trigger one or more actions to interrupt and/or mitigate these attacks. According to various aspects described herein, an analytics engine may generate a detection threshold based on the expected number of login failures to a service accessible by a plurality of users via their respective login credentials. This expected number of login failures may be estimated based on the observed or assumed number of login successes. The analytics engine may identify a number of login failures by a plurality of users to the service within a time window. The analytics engine may determine that the number of login failures to the service within the time window exceeds the detection threshold. The analytics engine may generate a notification corresponding to the service. The notification may indicate a security incident based on the number of login failures.

In one aspect, this disclosure is directed to a method. The method may include identifying, by an analytics engine, a detection threshold for login failures according to a number of login successes to a system. The method may include determining, by the analytics engine, a number of login failures by a plurality of users to the system within a time window. The method may include determining, by the analytics engine, that the number of login failures to the system within the time window exceeds the detection threshold. The method may include providing, by the analytics engine to a device, a notification indicating a potential security incident responsive to the number of login failures exceeding the detection threshold.

In some embodiments, the method may include determining the number of login failures to the system according to login statistics or login records. In some embodiments, a login failure includes one or more failed login attempts for one username. In some embodiments, the method includes identifying, by the analytics engine, login activity for each of a plurality of time windows. The login activity may include a number of login successes and a number of login failures for a corresponding time window. The method may include generating, by the analytics engine using the login activity, a distribution that the number of login failures is expected to follow. The method may include generating, by the analytics engine, the detection threshold according to the distribution.

In some embodiments, the distribution includes a Poisson distribution or a negative binomial distribution. In some embodiments, the method may include determining, by the analytics engine for each number of login successes to the system, an expected number of login failures to the system. The method may include generating, by the analytics engine for each number of login successes to the system, the detection threshold according to the expected number of login failures to the system. In some embodiments, the detection threshold corresponds to a defined quantile of the distribution.

In some embodiments, the method further includes receiving, by the analytics engine, a sensitivity value corresponding to the detection threshold. The method may include generating the detection threshold at a quantile of the distribution corresponding to the sensitivity value. In some embodiments, the method may include computing, by the analytics engine, a probability that the potential security incident is not a real security incident. The method may include triggering, by the analytics engine, an action for the system responsive to the probability satisfying a threshold. In some embodiments, the method may include computing the probability using a cumulative density function of a Poisson distribution at a point in the Poisson distribution corresponding to the number of login failures to the system.

In another aspect, this disclosure is directed to a device. The device may include at least one processor configured to implement an analytics engine. The analytics engine may be configured to identify a detection threshold for login failures according to a number of login successes to a system. The analytics engine may be configured to determine a number of login failures by a plurality of users to the system within a time window. The analytics engine may be configured to determine that the number of login failures to the system within the time window exceeds the detection threshold. The analytics engine may be configured to provide, to a first device, a notification indicating a potential security incident responsive to the number of login failures exceeding the detection threshold.

In some embodiments, the analytics engine determines the number of login failures to the system according to login statistics or login records. In some embodiments, a login failure includes one or more failed login attempts for one username. In some embodiments, the analytics engine is further configured to identify login activity for each of a plurality of time windows. The login activity may include a number of login successes and a number of login failures for a corresponding time window. The analytics engine may be configured to generate, using the login activity, a distribution that the number of login failures is expected to follow. The analytics engine may be configured to generate the detection threshold according to the distribution.

In some embodiments, the distribution includes a Poisson distribution or a negative binomial distribution. In some embodiments, the analytics engine is configured to determine, for each number of login successes to the system, an expected number of login failures to the system. The analytics engine may be configured to generate, for each number of login successes to the system, the detection threshold according to the expected number of login failures to the system. In some embodiments, the detection threshold corresponds to a defined quantile of the distribution.

In some embodiments, the analytics engine is further configured to receive a sensitivity value corresponding to the detection threshold. The analytics engine may be configured to generate the detection threshold at a quantile of the distribution corresponding to the sensitivity value. In some embodiments, the analytics engine is further configured to compute a probability that the potential security incident is not a real security incident. The analytics engine may compute the probability using a cumulative density function of a Poisson distribution at a point in the Poisson distribution corresponding to the number of login failures to the system. The analytics engine may be configured to trigger an action for the system responsive to the probability satisfying a threshold.

In another aspect, this disclosure is directed to a non-transitory computer readable medium storing program instructions for causing one or more processors to identify a detection threshold for login failures according to a number of login successes to a system. The instructions may further cause the one or more processors to determine a number of login failures by a plurality of users to the system within a time window. The instructions may further cause the one or more processors to determine that the number of login failures to the system within the time window exceeds the detection threshold. The instructions may further cause the one or more processors to provide, to a device, a notification indicating a potential security incident responsive to the number of login failures exceeding the detection threshold.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1 is a block diagram of a network computing system, in accordance with an illustrative embodiment;

FIG. 2 is a block diagram of a system for detecting a potential security incident, in accordance with an illustrative embodiment;

FIG. 3 depicts a chart graphically representing login statistics, in accordance with an illustrative embodiment;

FIG. 4 shows a chart showing an example time window in which components of the system of FIG. 2 may detect a potential security incident, in accordance with an illustrative embodiment; and

FIG. 5 is a flow chart showing a method for detecting a potential security incident, in accordance with an illustrative embodiment.

### DETAILED DESCRIPTION

For purposes of reading the description of the various embodiments below, the following descriptions of the sections of the specification and their respective contents may be helpful:

Section A describes a computing environment which may be useful for practicing embodiments described herein.

Section B describes systems and methods for detecting a potential security incident.

### A. Computing Environment

Prior to discussing the specifics of embodiments of the systems and methods detailed herein in Section B, it may be helpful to discuss the computing environments in which such embodiments may be deployed.

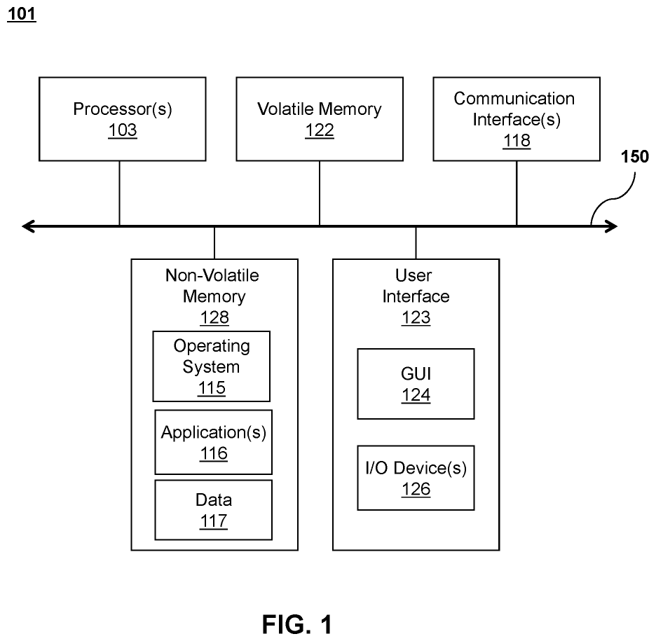

As shown in FIG. 1, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1 is shown merely as an example, as clients, servers, intermediary, and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital, or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

### B. Systems and Methods for Detecting a Potential Security Incident

In some aspects, this disclosure is directed to systems and methods for detecting a potential security incident. The systems and methods described herein may be configured to detect or identify various attempted attacks or other security incidents (such as password spraying, credential stuffing, or other types of incidents) to a system or service for instance. Briefly, the systems and methods described herein can compute or determine a detection threshold for a number of distinct failed login attempts (e.g., per username) to a system. A username may refer to a user identity (ID) or identifier associated with a user or user device. The threshold may adapt based on successful login attempts to the system, to provide an adaptive detection system that optimizes the detection threshold according to the “size” of the system and/or login activity.

In various computing environments, systems which are provided to clients may be password protected. Malicious actors or entities may attempt to access such systems by “attacking” the password protection system of such systems. For instance, an attempted attack may include a large number of login attempts against a large number of usernames, while keeping the number of login attempts per username low. The idea behind these attacks is that by keeping the number of login attempts per username low, they remain undetected by traditional security defenses which aim to detect brute force attacks on isolated users (e.g., which may block access via a username after a predetermined number of attempts to access a system using that particular username). Moreover, such attacks are designed to remain undetected by exploiting the fact that the number of legitimate failed login attempts across a system can be large and can have large variability. Examples of such attacks are password spraying attacks, credential stuffing attacks, and so forth. In the case of password spraying attacks, a small set of commonly used passwords are attempted against a large number of usernames for a system. In the case of credential stuffing attacks, previously discovered (e.g. stolen) account credentials, typically usernames and passwords which are separate from each other, are attempted in various combinations against a system.

The systems and methods described herein may be configured to provide detection (e.g., real-time detection) of such attacks or malicious activity, and thereby trigger one or more actions to interrupt and/or mitigate these attacks. According to various aspects described herein, an analytics engine may generate a detection threshold based on the expected number of login failures to a system that is accessible by a plurality of users via their respective login credentials. This expected number of login failures may be estimated based on the observed or assumed number of login successes. The analytics engine may identify a number of login failures by a plurality of users to the system within a time window. The analytics engine may determine that the number of login failures to the system within the time window exceeds the detection threshold. The analytics engine may generate a notification corresponding to the system. The notification may indicate or flag a security incident based on the number of login failures (e.g., exceeding the detection threshold).

The systems and methods described herein can have many benefits over other potential implementations of detection of security incidents to a system. For instance, by identifying the number of failed login attempts across a number of users, the systems and methods described herein may be configured to detect security incidents (such as password spraying, credential stuffing, etc.) which are otherwise difficult to detect. By comparing the number of failed login attempts to a threshold which changes with a “size” or login activity of a system (e.g., based on number of successful login attempts), the systems and methods described herein may dynamically adapt to various sizes and scales of systems. The threshold may have a selectable sensitivity to adapt to different types of systems. Various other benefits shall become apparent as followed.

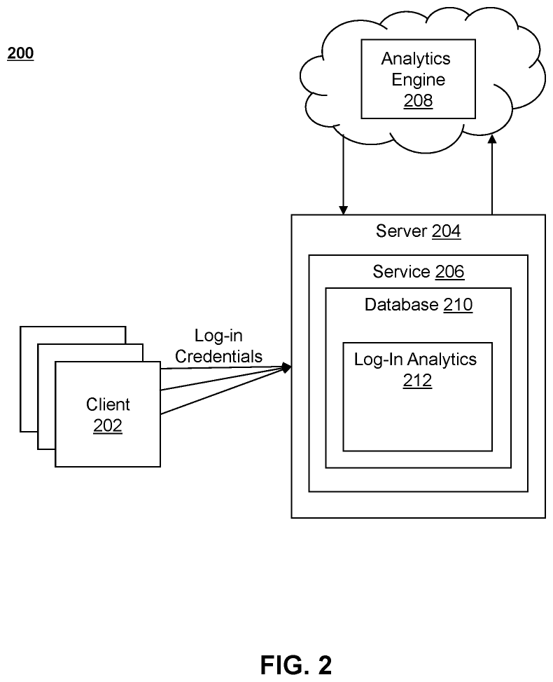

Referring now to FIG. 2, depicted is a system 200 for detecting a potential security incident, according to an implementation of the present disclosure. The system 200 may include a plurality of clients 202, one or more server(s) 204 hosting, executing, or otherwise providing one or more system(s) 206, and/or an analytics engine 208. The system 206 may prompt clients 202 or users for login credentials for accessing the system 206. The clients 202 (e.g., user devices or access terminals) may correspondingly provide login credentials to the server 204 hosting the system 206. A database 210 corresponding to the system 206 may be configured to store login analytics 212 (e.g., login attempts per internet protocol (IP) address, username(s) attempted, password(s) attempted globally, password(s) attempted per one or more client(s) 202, etc.). The analytics engine 208 may be configured to receive the login analytics 212 corresponding to login activity to the system 206. The analytics engine 208 may be configured to generate a detection threshold based on an average, median, mean, expected, estimated, minimum or maximum number of login failures to the system 206. The analytics engine 208 may be configured to identify a number of login failures by a plurality of users to the system 206 within a time window, may determine that the number of login failures to the system 206 within the time window exceeds the detection threshold, and may generate a notification corresponding to the determination, to the system 206. The notification may indicate a security incident based on or arising from the number of login failures (e.g., to the system 206). These and other aspects are described in further detail below.

The systems and methods of the present solution may be implemented in any type and form of device, including clients, servers, and/or appliances described above with reference to FIG. 1. For instance, the analytics engine 208 may be implemented at a server (which may be the same as or different from the server 204 hosting the system 206). Each of the clients 202 may be similar in some respects to the clients described above with reference to FIG. 1. The clients 202 may be communicably coupled to the server 204 hosting the system 206 (e.g., via one or more of the communications interfaces 118 described above). Similarly, the analytics engine 208 may be communicably coupled to the server 204 hosting the system 206. Hence, the client(s) 202, server 204, and/or analytics engine 208 may include or incorporate components and devices similar in some aspects to those described above with reference to FIG. 1, such as circuitry, a memory and/or one or more processors operatively coupled to the memory. Each component of the system 200 may include hardware, or a combination of hardware and software. The present systems and methods may be implemented in any embodiments or aspects of the appliances or devices described herein.

The system 200 may include a plurality of client(s) 202. The client(s) 202 may be or include any device(s) or component(s) designed or implemented to execute various application(s). The client(s) 202 may be, for instance, a personal computer (such as a laptop or desktop computer), a mobile device (such as a smartphone, a tablet, wearable device, etc.), and so forth. The client(s) 202 may be configured to access systems 206 hosted on the servers 204. The client(s) 202 may be configured to access the systems 206 by generating client requests for the server 204 (e.g., through or using a port of the server corresponding to the system 206). The client(s) 202 may be configured to generate the client requests when a user selects a system 206, or launches a system 206, when the client 202 is turned on, etc. In some embodiments, the client(s) 202 may be configured to transmit data corresponding to the system 206 with the client request.

The system 200 may include a server 204. The server 204 is shown to be communicably coupled to the client(s) 202 and analytics engine 208 in FIG. 2. While shown or described as a single server 204 in some implementations, the server 204 may include a plurality of servers 204. The server(s) 204 may include, maintain, or otherwise host one or more systems 206 (sometimes referred as services 206). The systems 206 may be various types or forms of software which may be accessible by (and provided to) the clients 202. In some embodiments, the system(s) 206 may be or include remote applications, software as a system (SaaS) applications, working environments, desktop sessions, etc. The system(s) 206 may be or include enterprise specific systems, devices and/or resources (e.g., systems which are specific to a single enterprise, developed by the enterprise, etc.), or may be accessible by a plurality of different enterprises, etc. While shown to be on the server 204, in some embodiments, the system(s) 206 may be local to or reside on the clients 202. For instance, the system(s) 206 may be an operating system of the client 202, applications executing locally at the client 202, etc. Hence, the system(s) 206 may be or include any combination of hardware and/or software which is accessible by users via their respective client 202.

In some embodiments, the system(s) 206 may request login credentials from clients 202 prior to providing the clients 202 access to the system 206. The login credentials may be or include a combination of a username (e.g., a unique name, an account number, a user identifier, etc.) and password (e.g., an alphanumeric passcode, pin, etc.) corresponding to a particular user. The system(s) 206 may prompt a user of the client 202 to enter, input, submit, or otherwise provide login credentials to the client 202. The client 202 may correspondingly transmit the login credentials provided by the user to the server 204 hosting and/or providing access to the system 206.

The system 200 may include a database 210. In some embodiments, the database 210 may be included in, maintained by, or otherwise embodied on the server 204 which hosts the system 206. In some embodiments, the database 210 may be embodied on a server separate from the server 204 (e.g., maintaining or providing access to the system 206). The database 210 may be configured to maintain, store, or otherwise include login analytics 212. The database 210 may include login analytics 212 corresponding to the system 206. In some embodiments, the database 210 may include login analytics 212 corresponding to a plurality of systems 206. The database 210 may be configured to store login analytics 212 for systems 206 on the server 204, for a plurality of servers (including the server 204), etc.

The login analytics 212 may include, for instance, login statistics, login records, or other data corresponding to login attempts to the system 206. The login analytics 212 may include a table (e.g., database or data structure) of login credentials (e.g., usernames and corresponding passwords). The table may be updated as new users register with the system 206 and provide login credentials to the system 206. The system 206 may be configured to receive the login credentials from clients 202, cross-reference the login credentials from the clients 202 with the login credentials in the database 210 to determine whether the user of a particular client 202 is registered with the system 206. The system 206 may perform a look-up function using the login credentials to determine whether a matching set of username and password is included in the database 210. Where the system 206 identifies a matching set of login credentials, the system 206 may be configured to provide the user of the client 202 access to the system 206. However, where the system 206 does not identify a matching set of login credentials, the system 206 may be configured to deny the user of the client 202 access to the system 206. The system 206 may be configured to prompt the user to enter alternative login credentials.

In some embodiments, the login analytics 212 may include login statistics (or records) corresponding to login attempts to the system 206. For instance, the login analytics 212 may include (e.g., for one or more time windows or periods) a number of successful login attempts (e.g., in total, number of successful login attempts per username, number of successful login attempts per password, etc.), a number of failed login attempts (e.g., in total, number of failed login attempts per username, number of failed login attempts per password, etc.), a timestamp for each login attempt, an IP address for each login attempt, etc. As described in greater detail below, the login analytics 212 may be used by the analytics engine 208 to detect attempted attacks, successful attacks, real/potentially malicious activity or other security incidents corresponding to the system 206.

The system 200 may include an analytics engine 208. The analytics engine 208 may be any device(s), component(s), element(s), script(s), application(s), and/or other combination of software and hardware designed or implemented to detect security incidents corresponding to the system 206. The analytics engine 208 may be communicably coupled to the database 210. In some embodiments, the analytics engine 208 may be embodied on, be a component of, or otherwise execute on a server which is communicably coupled to the server hosting the database 210. The analytics engine 208 may execute in a cloud-based environment. In some embodiments, the analytics engine 208 may be configured to receive the login analytics 212 from the database 210. The analytics engine 208 may be configured to process the login analytics 212 from the database 210 to detect security incidents corresponding to the system 206, as described in greater detail below.

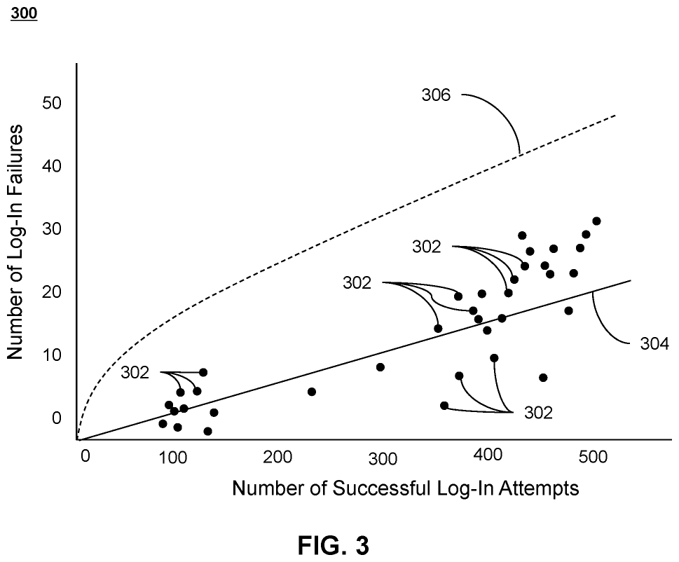

Referring now to FIG. 2 and FIG. 3, the analytics engine 208 may be configured to generate a detection threshold. Specifically, FIG. 3 depicts a chart 300 graphically representing login statistics corresponding to the system 206. As shown in FIG. 3, the chart 300 may include data points 302 representing login analytics 212 from the database 210. In some embodiments, each data point 302 may represent login analytics 212 for different time windows (e.g., different equal-length time windows). For instance, each data point 302 may represent login analytics 212 for a plurality of time windows (e.g., of a 24 hour period, for instance) to a system 206. Each time window corresponding to the data points 302 may have the same duration (e.g., 24 hours, for instance). Similarly, each time window may start and end at substantially the same time. Hence, each data point 302 may represent login analytics 212 from the database 210. Each data point 302 may represent a number of login successes and a number of login failures within a time window. Each login attempt and login failure may represent, account for or include multiple/all such attempts and logins, respectively, corresponding to a single username. For instance, where a client 202 submits a login attempt with a username and a password, the count for the number of successful or failed login attempts may increase by one depending on whether the login attempt was successful or unsuccessful. If the login attempt is unsuccessful, the number of login failures may increase by one. Where the client 202 submits another (failed) login attempt with the same username and a different password, the number of login failures may remain the same if the different password is incorrect. In other words, one login failure is equal to (or represents) one or more failed login attempts for one username. However, if the different password is correct, the number of successful login attempts may increase by one. Similarly, if a different client 202 (operated by the same user) submits another login attempt with the same username, it may not change the number of login successes and/or failures. Hence, the number of login successes and/or failures may be agnostic to attempts for different passwords and attempts on different clients 202, for the same login username.

The analytics engine 208 may be configured to identify, determine, compute, or otherwise generate a component 304 (e.g., an expected/mean/average trend or distribution) with respect to data points 302. The component 304 may correspond to a set of one or more distributions of successful login attempts or login failures. The component 304 may be or correspond to a distribution that the number of login failures is expected to follow. The component 304 may represent an expected number of login failures per the number of login successes. In some embodiments, the component 304 may be based on a linear function. The component 304 may be defined as:

r=ax+b

Eq. 1 where (x) is a number of login successes, (r) is an expected number of login failures corresponding to the number of login successes, and (a, b) are weights. The analytics engine 208 may be configured to analyze, parse, or otherwise compute the weights (a, b) based on the data retrieved from the database 210 corresponding to the login analytics 212, as described in greater detail below.

The analytics engine 208 may classify each data point 302 that may represent a distinct number of login successes and login failures (xᵢ,yᵢ) corresponding to different time windows of the same duration. Each number of login failures may represent a realization of a random variable yᵢ, which follows a distribution indicated by component 304. The distribution indicated by component 304 may be a Poisson distribution, a negative binomial distribution, etc. The analytics engine 208 may compute the probability of observing the number of login failures yᵢ for a particular number of login success xᵢ under a Poisson distribution according to equation 2 below:

$${p}_{i} = \frac{{r}_{i}^{{y}_{i}} {e}^{- {r}_{i}}}{{y}_{i} !}$$

Eq. 2 where rᵢ is the expected number of distinct login failures under equation 1. The analytics engine 208 may be configured to compute the probability of observing the login failures for each of the data points 302. Assuming each data point 302 is independent of other data points 302, the probability of observing all the data points 302 together may be the product of the probabilities of each of the individual data points 302, e.g., Πᵢ₌₁^{N}pᵢ. The analytics engine 208 may compute the weights (a,b) by maximizing the product of the individual probabilities.

The analytics engine 208 may be configured to compute weights (a,b) for distributions indicated by component 304 for a plurality of systems 206. In this regard, each component 304 may be particular to a respective system 206. In some implementations, the analytics engine 208 may re-compute weights (a,b) for distributions indicated by component 304 from time to time (e.g., randomly, at various intervals, responsive to a request by a system administrator, etc.). The analytics engine 204 may retrieve new login analytics 212 from the database 210 corresponding to the system 206, and can compute (e.g., determine, calculate) a new weight (a) based on the new login analytics 212. Such implementations may ensure that the estimated number of login failures is accurate based on further data in the database 210.

The analytics engine 208 may be configured to identify, determine, compute, or otherwise generate a detection threshold 306. The analytics engine 208 may be configured to generate the detection threshold 306 based on a number of login successes to the system 206. The analytics engine 208 may be configured to compute a detection threshold 306 for each possible number of login successes to the system 206. In other words, for a given number of login successes to the system 206, the analytics engine 208 may be configured to compute a corresponding detection threshold 306. Each number of login successes to the system 206 may include a point on the component 304 corresponding to the expected number of login failures, and corresponding to a detection threshold 306 which triggers a notification, as described in greater detail below. The analytics engine 208 may be configured to generate the detection threshold 306 at a quantile (e.g., 95 or 99% confidence level or probability) of the distribution indicated by component 304. The quantile may be preset, selectable, variable based on the number of login attempts, etc.

In some embodiments, the analytics engine 208 may be configured to obtain, retrieve, collect, or otherwise receive a sensitivity value (p) corresponding to the detection threshold 306. The analytics engine 208 may be configured to receive the sensitivity value (p) from an administrator or customer corresponding to the system 206. The analytics engine 208 may be communicably coupled to a device corresponding to the administrator. The administrator may input, select, or otherwise provide the sensitivity value (p) (e.g., based on a balance between likelihood of false positives of security incidents being detected and accuracy of the detection of security incidents). The analytics engine 208 may be configured to use the sensitivity value (p) for computing the detection threshold 306. Some example of sensitivity values may be or include, for instance, 5%, 3%, 2%, 1%, 0.5%, 0.1%, etc. The analytics engine 208 may be configured to compute the detection threshold 306 at a quantile of the distribution indicated by component 304. For instance, the analytics engine 208 may be configured to compute the detection threshold 306 at the 1-p quantile of the distribution. In other words, both the expected number of login failures (in the distribution indicated by component 304) and threshold 306 may both be a function of the number of login successes. As such, the detection threshold 306 computed by the analytics engine 208 is adaptive to the volume of successful login attempts to the system 206.

The analytics engine 208 may be configured to compute the detection threshold 306 for each potential number of login successes to the system 206 within the time window. The analytics engine 208 may be configured to determine an expected number of login failures to the system 206 using the distribution indicated by component 304. The analytics engine 208 may identify the expected number of login failures to the system 206 for each potential number of login successes to the system 206. The analytics engine 208 may be configured to compute the detection threshold 306 for each expected number of login failures (e.g., as represented in or determined using the distribution indicated by component 304).

The analytics engine 208 may be configured to compute the detection threshold 306 in advance of monitoring real-time login analytics 212 received from the database 210 and corresponding to the system 206. Responsive to computing the detection threshold, the analytics engine 208 may be configured to monitor or acquire real-time login analytics 212 to detect security incidents. The analytics engine 208 may be configured to receive login analytics 212 at time windows. For instance, the analytics engine 208 may be configured to receive login analytics at each hour, at each two hours, at each 24 hour period, etc. The analytics engine 208 may be configured to detect security incidents using the login analytics 212 for a time window and corresponding detection thresholds 306, as described in greater detail below.

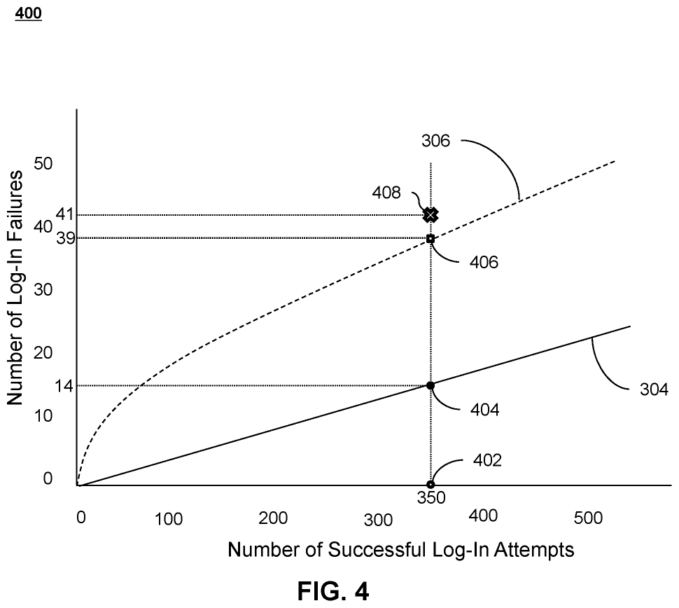

Referring now to FIG. 4, depicted is a chart 400 showing an example time window in which the analytics engine 208 may detect a potential security incident, according to an illustrative embodiment. The analytics engine 208 may be configured to identify, detect, or otherwise determine a number of successful login attempts 402 for a time window. The time window may be a time window which is the same duration as the time window for the data points 302 used for computing the distribution indicated by component 304 and/or detection thresholds 306. The analytics engine 208 may be configured to use the number of login attempts 402 within the time window for identifying a corresponding expected number of login failures 404 and/or detection threshold 406. As stated above, each value on the distribution indicated by component 304 and detection threshold 306 may have a corresponding number of successful login attempts. The analytics engine 208 may be configured to identify the expected number of login failures 404 and detection threshold 406 which corresponds to the number of successful login attempts 402 received from the database 210 for the time window.

The analytics engine 208 may be configured to receive, determine, or otherwise identify a number of login failures 408 in the time window. The number of login failures 408 may be the actual number of login failures 408 during the time window for the number of successful login attempts 402. The analytics engine 208 may be configured to identify the number of login failures 408 in real-time or near real time (e.g., offset by 1 second, 1 minute or other duration). The analytics engine 208 may be configured to compare the number of login failures 408 to the detection threshold 406 corresponding to the number of successful login attempts 402.

The analytics engine 208 may be configured to generate notifications corresponding to the system 206. The analytics engine 208 may be configured to generate the notification when the number of login failures 408 to the system 206 exceeds the detection threshold 406. The notification may indicate a security incident based on the number of login failures 408 and/or the detection threshold 406. In some embodiments, the notification may be transmitted to the system 206, to an administrator corresponding to the system 206, etc. In some embodiments, the notification may trigger one or more actions (e.g., shutting down the system 206, shutting down access to the system 206, blocking further login attempts to the system 206, blocking IP addresses corresponding to the failed login attempts, etc.).

In some embodiments, the analytics engine 208 may be configured to generate the notification responsive to the analytics engine 208 determining the probability of the security incident being detected. The analytics engine 208 may be configured to compute a probability that the potential security incident is not a real security incident, or is a real security incident. In some implementations, the analytics engine 208 may be configured to compute a probability of observing the number of login failures 408 to the system 206 and that the system 206 is not experiencing a security incident. For instance, the analytics engine 208 may be configured to compute the probability using a cumulative density function with respect to the expected number of login failures 404. Thus, the analytics engine 208 may be configured to compute the probability using a cumulative density function of the distribution indicated by component 304 (e.g., a Poisson distribution, negative binomial distribution, etc.) at a point in the distribution indicated by component 304 corresponding to the number of login successes 402 to the system 206. The analytics engine 208 may be configured to determine a confidence (level) of the security incident based on the computed probability. The confidence may decrease in proportion to the computed probability. Hence, as the probability (e.g., of observing login failures to the system 206 and the system not experiencing a security incident) increases, the confidence may decrease. The analytics engine 208 may be configured to transmit the notification to trigger one or more responses by the system responsive to the probability of the potential security incident satisfying a threshold (e.g., meeting or exceeding a threshold confidence in the security incident).

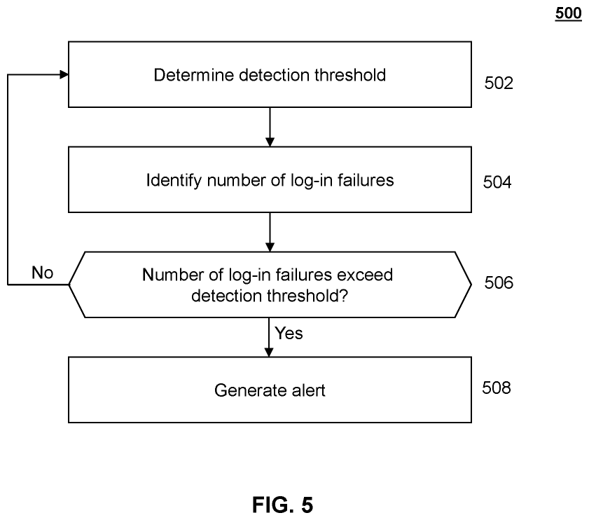

Referring now to FIG. 5, an implementation of a method 500 for detecting a potential security incident shall be described. In brief overview of method 500, at step 502, an analytics engine identifies a detection threshold. At step 504, the analytics engine determines a number of login failures. At step 506, the analytics engine determines whether the number of login failures exceeds the detection threshold. At step 508, the analytics engine provides a notification.

At step 502, and in some embodiments, an analytics engine identifies a detection threshold. In some embodiments, the analytics engine may identify the detection threshold for login failures according to a number of login successes to a system. The system may be accessible by users via respective login credentials. The system may request login credentials from clients operated by respective users prior to providing the client access to the system. Users may provide their login credentials (e.g., a username and password) to a user interface corresponding to the system at the client. The client may transmit, send, or otherwise provide the login credentials of the user to the system. The system may validate or authenticate the user using the login credentials.

In some embodiments, the system may maintain, include, or otherwise be associated with a database. The database may include login analytics. The login analytics may include login statistics or login records for the system. In some embodiments, the login analytics may include login credentials for registered users, login statistics corresponding to login attempts (e.g., number of login successes, number of login failures, etc.). The system may validate (e.g., authenticate) users by cross-referencing the login credentials from the user with login credentials of registered users in the database. The system may provide access to the client where the system successfully validates the user (e.g., by the user providing proper or valid login credentials). The system may update the database (or cause the database to be updated) based on the login attempts. The system may update the database to include up-to-date data on successful and failed login attempts. The system may update the database dynamically, in real-time or near real time (e.g., as clients attempt to log into the system with login credentials).

The system may update the database to include login statistics on a per-username basis within a time window. As such, successful and failed login attempts may be counted per username. For example, where a user attempts multiple passwords with the same username, the number of failed login attempts may only increase by one (despite the number of attempts). On the other hand, where a user successfully logs in on multiple devices using the same username and within the same time window, the number of successful login attempts may only increase by one (despite the user successfully logging in multiple times within the time window). Accordingly, a login failure is equal to (or represents) one or more failed login attempts for one username. Similarly, a login success is equal to (or represents) one or more successful login attempts for one username.

In some embodiments, the analytics engine may receive login analytics from the database. The analytics engine may receive the login analytics in real-time, at various intervals, etc. The analytics engine may analyze, parse, or otherwise use the login analytics for generating a detection threshold. The analytics engine may generate the detection thresholds for a number of possible successful login attempts. The analytics engine may generate the detection threshold for the total number of possible successful login attempts for a given time window. The time window may be a 24 hour period, for instance. The total number of possible successful login attempts may be, for instance, the total number of registered users of the system (which may be included or determined based on the login analytics for the system).

The analytics engine may generate the detection threshold by generating a distribution of successful login attempts and/or failed login attempts. The failed login attempts may be estimated based on an observed or assumed number of successful login attempts, or vice versa, in some embodiments. The analytics engine may compile the data from the login analytics for generating the distribution. The analytics engine may generate the distribution using the login analytics for various time windows (e.g., of a same duration). Each time window may represent one data point which is used for generating the distribution. Each time window for a respective data point may be the duration and span the same time of day. In other words, each time window may mirror the other time windows for the data points. The data points may include a number of login successes and a number of login failures for a respective time window. The analytics engine may generate the distribution using the data points. The analytics engine may generate the detection threshold as a function of the distribution of login attempts and login failures. In some embodiments, the distribution may be a Poisson distribution, a negative binomial distribution, etc. For instance, where the analytics engine generates a Poisson distribution, the analytics engine may use Poisson analysis and/or regression of the data points to generate the Poisson distribution. The analytics engine may use equation 1 and equation 2 described in greater detail above for generating the distribution.

The analytics engine may generate the detection threshold as a function of the distribution of login successes and/or (estimated) login failures. The analytics engine may generate a detection threshold for each possible number of login successes to the system within the time window. The analytics engine may generate the detection threshold by first determining a number of login successes within a time window. The analytics engine may determine an expected number of login failures for the number of login successes. The analytics engine may determine the expected number of login failures based on data from the distribution (e.g., which represents a number of login successes and estimated number of login failures). The analytics engine may generate the detection threshold based on the expected number of login failures to the system. The analytics engine may generate the detection threshold as a function of the expected number of login failures (e.g., according to the distribution). The analytics engine may generate the detection threshold for each potential number of successful login attempts from the distribution. The analytics engine may generate the detection threshold prior to deployment (e.g., prior to being used to detect security incidents). The analytics engine may generate the detection threshold at a quantile from the distribution. The quantile may be fixed relative to the distribution, or variable, preset, selectable, etc.

In some embodiments, the analytics engine may receive a sensitivity value corresponding to the detection threshold. The analytics engine may receive the sensitivity value during a training phase of the detection threshold. The analytics engine may receive the sensitivity value from a computing device associated with an administrator of the system. The analytics engine may use the sensitivity value for generating the detection threshold. The sensitivity value may control the sensitivity of the analytics engine for detecting security incidents. As the sensitivity value changes, the number of security incidents may correspondingly change. An administrator of the system may select, input, or otherwise provide the sensitivity value to their respective computing device for the analytics engine based on a balance between sensitivity of the system (e.g., likelihood of false positives) and desired security (e.g., likelihood of missing a security incident). The analytics engine may receive the sensitivity value from the computing device corresponding to the administrator of the system. In some embodiments, the analytics engine may use the sensitivity value (and the distribution) for computing or generating the detection threshold. The analytics engine may generate the detection threshold at a quantile of the distribution which corresponds to the sensitivity value.

The analytics engine may identify a detection threshold. The analytics engine may identify a detection threshold corresponding to a number of successful login attempts within a time window. The analytics engine may identify the detection threshold in real-time (e.g., during deployment). The analytics engine may identify the detection threshold by determining a number of login successes for a time window (e.g., which is the same time window as used for generating the distribution and corresponding detection thresholds). The analytics engine may identify the detection threshold based on the number of login successes for the time window. The analytics engine may use the detection threshold for identifying security incidents, as described in greater detail below.

At step 504, and in some embodiments, the analytics engine determines a number of login failures. In some embodiments, the analytics engine may determine a number of login failures by a plurality of users to the system within the time window. The time window for identifying the number of login failures may be the same as the time window used for determining the number of login successes (e.g., used for determining the detection threshold). The analytics engine may identify the number of login failures on a per-username basis based on data (e.g., data corresponding to login analytics) received from the database corresponding to the system.

At step 506, and in some embodiments, the analytics engine determines whether the number of login failures exceeds the detection threshold. In some embodiments, the analytics engine may determine that the number of login failures to the system (e.g., determined at step 504) exceeds the detection threshold (e.g., identified at step 502). Where the number of login failures does not exceed the detection threshold, the method 500 may loop back to step 502. In other words, the analytics engine may adaptively identify (e.g., for a next time instance) a detection threshold (e.g., based on the number of login successes to the system), determine the number of login failures, and compare the number of login failures to the detection threshold. The analytics engine may compare the number of login failures to the detection threshold in real-time (e.g., at various time instances, sequentially). As the analytics engine receives further login analytics, the analytics engine may loop between steps 502 through 506. The analytics engine may loop between steps 502 through steps 506 until the analytics engine determines the number of login failures exceeds the detection threshold determined at step 502. Where the analytics engine determines that the number of login failures to the system within the time window exceeds the detection threshold, the method 500 may proceed to step 508.

At step 508, and in some embodiments, the analytics engine provides a notification. In some embodiments, the analytics engine may provide the notification to a device. The notification may indicate a potential security incident responsive to the number of login failures exceeding the detection threshold. The analytics engine may provide the notification to the server hosting the system, to the computing device corresponding to the administrator or a user of the system, etc. The notification may trigger one or more actions corresponding to the system in response to the detected security incident. The actions may be or include shutting down the system, preventing further access to the system by a subset or all clients, sending a warning, limiting access to the system, requiring a change to login credentials, etc. The actions may include inaction or dismissing the notification (e.g., where an administrator reviews the login statistics or records and determines that the potential security incident is not a real security incident).

In some embodiments, the analytics engine may generate the notification responsive to determining a confidence of the security incident. In some embodiments, the analytics engine may determine the confidence based on a probability of observing the number of login failures to the system and the system is not experiencing a security incident. The analytics engine may compute the probability based on the degree in which the number of login failures to the system exceeds the expected amount of login failures, exceeds the detection threshold, etc. The analytics engine may compute the probability using a cumulative density function of the distribution (e.g., the Poisson distribution generated as described above with reference to step 502) at a point in the distribution corresponding to the number of login failures to the system. Hence, the analytics engine may compute the probability based on the expected number of failed login attempts. The analytics engine may determine a confidence of the security incident based on the computed probability. The confidence may decrease in proportion to the probability. For instance, as the probability of observing the number of login failures to the system (and the system not experiencing a security incident) increases, the confidence correspondingly decreases. On the other hand, as the probability of observing the number of login failures (or a larger number) to the system (and the system not experiencing a security incident) decreases, the confidence correspondingly increases. The analytics engine may compare the confidence to a threshold confidence (level). The analytics engine may trigger one or more responses by the system responsive to the confidence exceeding the threshold (e.g., indicating it is likely that a security incident is occurring). The one or more responses may include, for instance, the system denying access to all users, subsequent users, users associated with IP addresses corresponding to the failed login attempts, locking an account, shutting down the system, etc. Such responses may be automatically taken by the system, taken responsive to approval by an administrator of the system, recommended to the administrator to take, etc.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

We claim:

1. A method comprising:
identifying, by an analytics engine, a detection threshold for login failures according to a number of login successes to a system;
determining, by the analytics engine, a number of login failures by a plurality of users to the system within a time window;
determining, by the analytics engine, that the number of login failures to the system within the time window exceeds the detection threshold; and
providing, by the analytics engine to a device, a notification indicating a potential security incident responsive to the number of login failures exceeding the detection threshold.

2. The method of claim 1, comprising determining the number of login failures to the system according to login statistics or login records.

3. The method of claim 1, wherein a login failure comprises one or more failed login attempts for one username.

4. The method of claim 1, further comprising:
identifying, by the analytics engine, login activity for each of a plurality of time windows, wherein the login activity includes a number of login successes and a number of login failures for a corresponding time window;
generating, by the analytics engine using the login activity, a distribution that the number of login failures is expected to follow; and
generating, by the analytics engine, the detection threshold according to the distribution.

5. The method of claim 4, wherein the distribution comprises a Poisson distribution or a negative binomial distribution.

6. The method of claim 4, comprising:
determining, by the analytics engine for each number of login successes to the system, an expected number of login failures to the system; and
generating, by the analytics engine for each number of login successes to the system, the detection threshold according to the expected number of login failures to the system.

7. The method of claim 4, wherein the detection threshold corresponds to a defined quantile of the distribution.

8. The method of claim 6, further comprising:
receiving, by the analytics engine, a sensitivity value corresponding to the detection threshold; and
generating the detection threshold at a quantile of the distribution corresponding to the sensitivity value.

9. The method of claim 1, further comprising:
computing, by the analytics engine, a probability that the potential security incident is not a real security incident;
triggering, by the analytics engine, an action for the system responsive to the probability satisfying a threshold.

10. The method of claim 9, further comprising computing the probability using a cumulative density function of a Poisson distribution at a point in the Poisson distribution corresponding to the number of login failures to the system.

11. A device, comprising:
at least one processor configured to implement an analytics engine, the analytics engine configured to:
identify a detection threshold for login failures according to a number of login successes to a system;
determine a number of login failures by a plurality of users to the system within a time window;
determine that the number of login failures to the system within the time window exceeds the detection threshold; and
provide, to a first device, a notification indicating a potential security incident responsive to the number of login failures exceeding the detection threshold.

12. The device of claim 11, wherein the analytics engine determines the number of login failures to the system according to login statistics or login records.

13. The device of claim 11, wherein a login failure comprises one or more failed login attempts for one username.

14. The device of claim 11, wherein the analytics engine is further configured to:
identify login activity for each of a plurality of time windows, wherein the login activity includes a number of login successes and a number of login failures for a corresponding time window;
generate, using the login activity, a distribution that the number of login failures is expected to follow; and
generate the detection threshold according to the distribution.

15. The device of claim 14, wherein the distribution comprises a Poisson distribution or a negative binomial distribution.

16. The device of claim 14, wherein the analytics engine is configured to:
determine, for each number of login successes to the system, an expected number of login failures to the system; and
generate, for each number of login successes to the system, the detection threshold according to the expected number of login failures to the system.

17. The device of claim 14, wherein the detection threshold corresponds to a defined quantile of the distribution.

18. The device of claim 16, wherein the analytics engine is further configured to:
receive a sensitivity value corresponding to the detection threshold; and
generate the detection threshold at a quantile of the distribution corresponding to the sensitivity value.

19. The device of claim 11, wherein the analytics engine is further configured to:
compute a probability that the potential security incident is not a real security incident, the analytics engine computing the probability using a cumulative density function of a Poisson distribution at a point in the Poisson distribution corresponding to the number of login failures to the system; and
trigger an action for the system responsive to the probability satisfying a threshold.

20. A non-transitory computer readable medium storing program instructions for causing one or more processors to:
identify a detection threshold for login failures according to a number of login successes to a system;
determine a number of login failures by a plurality of users to the system within a time window;
determine that the number of login failures to the system within the time window exceeds the detection threshold; and
provide, to a device, a notification indicating a potential security incident responsive to the number of login failures exceeding the detection threshold.
